(19) United States
(12) Patent Application Publication
(10) Pub. No.: US 2025/0259155 A1
(43) Pub. Date: Aug. 14, 2025

(54) SYSTEMS, METHODS AND DEVICES FOR RETAIL CRYPTOCURRENCY TRANSACTIONS

(71) Applicant: SPARX NOVATE, LLC, NEW YORK, NY (US)

(72) Inventor: ISAAC S. DANIEL, PARKLAND, FL (US)

(73) Assignee: SPARX NOVATE, LLC, NEW YORK, NY (US)

(21) Appl. No.: 19/196,415

(22) Filed: May 1, 2025

Related U.S. Application Data
(63) Continuation-in-part of application No. 18/144,361, filed on May 8, 2023.
(60) Provisional application No. 63/317,055, filed on Mar. 6, 2022.

(51) Int. Cl. G06Q 20/06; G06Q 20/20; G06Q 20/32; G06Q 20/34; G06Q 20/40

(52) U.S. Cl. CPC G06Q 20/065; G06Q 20/204; G06Q 20/3278; G06Q 20/3574; G06Q 20/40145

(57) ABSTRACT

Systems, computer-implemented methods, devices and computer programmable product directed to operation of a retail financial cryptocurrency network or platform are disclosed. Validations methods for validating users and use of devices in the retail financial cryptocurrency network or platform wirelessly, along with supporting elements and devices are also disclosed.

### CROSS-REFERENCE TO RELATED APPLICATIONS AND PRIORITY CLAIMS

This patent application is a Continuation-In-Part application of, and claims priority to, U.S. Non-Provisional patent application Ser. No. 18/144,361 titled “SYSTEMS, METHODS AND DEVICE FOR RETAIL CRYPTOCURRENCY TRANSACTIONS”, filed May 8, 2023, and further claims priority under 35 U.S.C. § 119(e) to U.S. Provisional Patent Application Ser. No. 63/317,055, titled “SYSTEMS, METHODS AND DEVICE FOR RETAIL CRYPTO TRANSACTIONS” filed Mar. 6, 2022. The entire disclosure of the aforementioned patent applications are incorporated by reference as if fully stated herein.

### FIELD OF THE INVENTION

The present invention is generally related to computer implemented methods, processes, systems, platforms, computer program product, and devices directed to, inter alia, the enabling and implementation of a retail cryptocurrency transaction financial network and devices.

### BACKGROUND OF THE INVENTION

Cryptocurrencies are quickly growing in popularity and becoming mainstream currencies. From cryptocurrency ATMs to global businesses accepting digital currency as a form of payment, retailers are following suit. With time, cryptocurrency will be the preferred payment method of the future. Since the first transaction, it has become a more accepted ledger. From exchanges to digital wallets, people around the world are buying and making domestic and international purchases with cryptocurrency.

Because of the decentralized nature of cryptocurrency, which cuts out the middleman, more and more retailers are using cryptocurrency to do business. This allows retailers to receive payments in real time with little to no transaction fees.

However, the current process of crypto acceptance in the retail space is not as streamlined as one may think. While online purchases are more easily accepted and processed, they tend to include a third-party crypto processing application which is required for both parties. For instance, if one wishes to pay for an in-store purchase in person, the process is still in development and is not brand agnostic.

Aspects of embodiments of the present invention contemplate computer implemented methods, processes, systems, platforms, computer program product, and devices directed to the operation of a crypto network using a Hyperledger with a proprietary software platform that retailers as well as developers for retailers can use to create new applications.

Aspects of embodiments of the present invention contemplate computer implemented methods, processes, systems, platforms, computer program product, and devices that are business-agnostic and can facilitate cryptocurrency acceptance for any business, large or small, online or in person.

Aspects of embodiments of the present invention also contemplate a network which utilizes a token for retail adoption and use.

Advantages of the contemplated invention include its general accessibility for use by the general public, retailers etc. This is made possible by the openness and eventual and centralization of cryptocurrency.

Additional advantages of aspects of embodiment of the present invention include the ability of the contemplated invention to enable retail businesses to create rewards for their users. Aspects of embodiments of the present invention also enable users to save on taxes from direct purchases from dealers or high expenses of fashion products.

This may be made possible following the acceptance of the payment system(s) contemplated by aspects of embodiments of the present invention, as a result of the openness and centralization of cryptocurrency. There may also be strategic benefits for government or states to give tax incentives for specific industries.

Aspects of embodiments of the contemplated invention also eliminates the need for third-party processing platforms or middlemen, thereby saving the users from processing costs.

Another advantage of an aspect of an embodiment of the present invention, is the ability of users to roll over their change to their account within the system when making purchases from retailers that also use the system.

Typically, following certain purchases, there may be coins, or change left. Roll-over or extension as contemplated by aspect(s) of embodiment(s) of the present invention, eliminates the hassle of dealing with a pile of coins that accumulates after receiving change in the form of coins over a period of time. Such roll-over allows users to spend their change with the convenience of a fiat card, view their balance & transactions with either on their desktop dashboard or a fiat mobile application, all according to aspect(s) of embodiment(s) of the present invention. This would eliminate retailers' need for their cashiers to count and dispense coins or change for their customers in cash/fiat. This concept would also save time as cashiers would no longer be required to spend the time counting and providing customers with their change. Rather, cashiers would only have to transfer the change through the contemplated system, according to aspect(s) of embodiment(s) of the present invention, to the customer's card. This is also a major point, as it provides a critical security feature for both customers and retailers.

In addition, customers will have a better currency management, as they no longer would have to worry about the need to leave change/coins such as in restaurants/coffee shops where sometimes customers tend to walk away due to time constraint on waiting for their cash change.

### SUMMARY OF THE INVENTION

Aspects of embodiments of the present invention contemplate computer-implemented methods, computer program product, systems and devices that, inter alia, enable and implement operation of a retail cryptocurrency transaction financial network and associated devices.

In an aspect of an embodiment of the present invention, the retailer may take the following steps to accept cryptocurrency: obtain a cryptocurrency address, print and post the retailer's QR code, wait for processing of transaction(s), cash out.

Retailers seeking to take part in the system as contemplated by aspects of embodiments of the present invention, may first purchase the designated cryptocurrency, incorporate an application programming interface (API) (contemplated by aspect(s) of embodiments of the present invention) into the retailer's payment platform. Alternatively, the retailer could use a Point of Sale (POS) terminal or device (contemplated by aspect(s) of embodiments of the present invention). When making purchase(s), customers are enabled by the system contemplated by aspect(s) of embodiments of the present invention to round up their payment and add their change to their coin via the API.

Aspects of embodiments of the present invention may be used by a variety of retailers such as department stores, specialty stores, supermarkets, convenience stores, discount stores, super stores/hypermarkets, warehouse stores, e-commerce store, dollar stores and drug stores.

An aspect of an embodiment of the present invention contemplates a system configured towards implementation of a retail cryptocurrency transaction financial network, which may include: at least one processor configured to perform a predefined set of basic operations in response to receiving a corresponding basic computer executable instruction selected from a predefined native instruction set of codes, at least one database, at least one payment card, where the at least one payment card may include any one or more of: a Key Signature Pin, a biometric fingerprint sensor, and at least one point of sale (POS) device, where the POS device verifies a user's signature on the at least one payment card, where all components of the system are any one of: in communication with each other, in communication with at least one other element of the system.

In aspect of an embodiment of the present invention, the system may further include at least one portable device, in communication with any one or more of: the at least one processor, at least one database, at least one POS, at least one payment card, where the at least one portable device may include any one or a combination of: a biometric module, biometric information, a transceiver module, a computer processor unit, coded information, memory.

In aspect of an embodiment of the present invention, the system may further include text data stored on the at least one database.

In aspect of an embodiment of the present invention, the text data may include of at least one captured signature image.

In aspect of an embodiment of the present invention, the text data is encoded into a cryptographically signed binary file.

In aspect of an embodiment of the present invention, the system may further include at least one stored element, where the cryptographically signed binary file may be transmitted to the at least one stored element and where the at least one stored element may be read via Near-Field Communication (NFC).

An aspect of an embodiment of the present invention also contemplates a system configured towards implementation of a retail cryptocurrency transaction financial network, comprising: at least one processor configured to perform a predefined set of basic operations in response to receiving a corresponding basic computer executable instruction selected from a predefined native instruction set of codes, at least one database, at least one payment card, where said at least one payment card comprises of any one or more of: a Key Signature Pin, a biometric fingerprint sensor, a verification and authentication module, a transceiver, memory, a transceiver, and at least one point of sale (POS) device, where said POS device verifies a user's signature on said at least one payment card, where all components of said system are any one of: in communication with each other, in communication with at least one other element of said system.

In an aspect of an embodiment of the present invention, the system may additionally include at least one portable device, in communication with any one or more of: said at least one processor, at least one database, at least one POS, at least one payment card, where said at least one portable device comprises of any one or a combination of: a biometric module, biometric information, a transceiver module, a computer processor unit, coded information, memory.

In an aspect of an embodiment of the present invention, the system may additionally include bioprint data stored on said memory of said at least one payment card.

In an aspect of an embodiment of the present invention, the bioprint data may be encoded into a cryptographically signed binary file.

In an aspect of an embodiment of the present invention, the system may include at least one stored element, where said cryptographically signed binary file may be transmitted to said at least one stored element and where said at least one stored element may be read via Near-Field Communication (NFC).

Another aspect of an embodiment of the present invention contemplates a computer-implemented method for implementing operation of a retail cryptocurrency transaction financial network, comprising executing on at least one processor, the steps of: enabling purchase and installation of least one type of cryptocurrency as designated by the retail cryptocurrency transaction financial network, incorporation, by a retail location, of at least one application programming interface (API) linked or relevant to the at least one type of cryptocurrency into the retail location's payment platform, and operation of the retail cryptocurrency transaction financial network once the at least one API has been integrated with the retail location's payment platform.

Another aspect of an embodiment of the present invention contemplates a computer-implemented method for implementing operation of a retail cryptocurrency transaction financial network, comprising executing on at least one processor configured to perform a predefined set of basic operations in response to receiving a corresponding basic computer executable instruction selected from a predefined native instruction set of codes, the steps of: enabling purchase and installation of least one type of cryptocurrency as designated by the retail cryptocurrency transaction financial network, and operation, by a retail location, of at least one point of sale terminal linked to the cryptocurrency transaction financial network, and operation of the retail cryptocurrency transaction financial network once the at least one API has been integrated with the retail location's payment platform.

Another aspect of an embodiment of the present invention contemplates a computer-implemented method for implementing operation of a retail cryptocurrency transaction financial network, comprising executing on at least one processor configured to perform a predefined set of basic operations in response to receiving a corresponding basic computer executable instruction selected from a predefined native instruction set of codes, the steps of: enabling purchase and installation of least one type of cryptocurrency as designated by the retail cryptocurrency transaction financial network, and operation, by a retail location, of at least one point of sale terminal linked to the cryptocurrency transaction financial network, and operation of the retail cryptocurrency transaction financial network once the at least one API has been integrated with the retail location's payment platform.

Another aspect of an embodiment of the present invention contemplates a computer-implemented method for verifying a user's signature on a payment card instantly, the method comprising executing on at least one processor configured to perform a predefined set of basic operations in response to receiving a corresponding basic computer executable instruction selected from a predefined native instruction set of codes, the steps of: receiving data from at least one payment card, searching for data previously supplied by the user, where the data was obtained by an Optical Character Recognition (OCR) process during the user's application for at least any one or more of: a credit card, debit card, cryptocurrency payment card or digital wallet, and where the data is sent from at least one device, submitting the received data to a centralized database, comparing the received data with data located within the centralized database, matching the received data with previously supplied data already within the centralized database, extracting text data from the previously supplied data already within the centralized database, and encoding the text data from the previously supplied data already within the centralized database.

In another aspect of an embodiment of the present invention, the received data may comprise of any one of: an entire captured signature image, a portion of a captured signature image.

In another aspect of an embodiment of the present invention, the encoded text data is encoded into a cryptographically signed binary file.

In another aspect of an embodiment of the present invention, the validity of the cryptographically signed binary file may be confirmed by comparing its signature to an expected signature based on supplied parameters.

In another aspect of an embodiment of the present invention, the computer-implemented method may further comprise the step of transmitting the signed binary file to a secure element where it is housed.

In another aspect of an embodiment of the present invention, the secured element may be a computer chip.

In another aspect of an embodiment of the present invention, the secure element is configured and enabled to be read via Near-field Communication (NFC) for verification purposes without a wireless network being present or being used.

Another aspect of an embodiment of the present invention contemplates a computer-implemented method for implementing operation of a retail cryptocurrency transaction financial network, comprising executing, on at least one processor configured to perform a predefined set of basic operations in response to receiving a corresponding basic computer executable instruction selected from a predefined native instruction set of codes, steps of: enabling purchase and installation of least one type of cryptocurrency as designated by the retail cryptocurrency transaction financial network, incorporation, by a retail location, of at least one application programming interface (API) linked or relevant to the at least one type of cryptocurrency into the retail location's payment platform, verification and authentication of a bioprint as received by at least one payment card, where the verification and authentication is undertaken by a verification and authentication module of the at least one payment card, and operation of the retail cryptocurrency transaction financial network once the at least one API has been integrated with the retail location's payment platform.

In another aspect of an embodiment of the present invention, the computer-implemented method undertaken by the verification and authentication module of the at least one payment card, may include steps of: receiving data on the at least one payment card, searching for data previously supplied by the user, where the data is stored on memory of the at least one payment card, comparing the received data with previously stored data located on the memory of the at least one payment card, and determining whether a match exists between the received data with previously supplied data already stored within the memory of the at least one payment card.

In another aspect of an embodiment of the present invention, the computer-implemented method may include the step of transmitting confirmation of the match to a secure element where it is housed.

In another aspect of an embodiment of the present invention, the secure element may be configured and enabled to be read via Near-field Communication (NFC) for verification purposes without a wireless network being present or being used.

A further aspect of an embodiment of the present invention contemplates a computer program product comprising a computer usable medium having computer executable instructions stored therein for causing a computer processor to verify a payment card transaction, the computer executable instructions comprising computer readable program code for: enabling purchase and installation of least one type of cryptocurrency as designated by the retail cryptocurrency transaction financial network, incorporation, by a retail location, of at least one application programming interface (API) linked or relevant to the at least one type of cryptocurrency into the retail location's payment platform, and operation of the retail cryptocurrency transaction financial network once the at least one API has been integrated with the retail location's payment platform.

A further aspect of an embodiment of the present invention contemplates a computer program product comprising a computer usable medium having computer executable instructions stored therein for causing a computer processor to verify a payment card transaction, the computer executable instructions comprising computer readable program code for: receiving data from at least one payment card, searching for data previously supplied by the user, where the data was obtained by an Optical Character Recognition (OCR) process during the user's application for at least any one or more of: a credit card, debit card, cryptocurrency payment card or digital wallet, and where the data is sent from at least one device, submitting the received data to a centralized database, comparing the received data with data located within the centralized database, matching the received data with previously supplied data already within the centralized database, extracting text data from the previously supplied data already within the centralized database, and encoding the text data from the previously supplied data already within the centralized database.

In a further aspect of an embodiment of the present invention, the received data of the computer program product may comprise of any one of: an entire captured signature image, a portion of a captured signature image.

In a further aspect of an embodiment of the present invention, the encoded text data of the computer program product may be encoded into a cryptographically signed binary file.

In a further aspect of an embodiment of the present invention, the computer program product may include computer readable program code for comparing the signature of the cryptographically signed binary file to an expected signature based on supplied parameters to confirm validity of the cryptographically signed binary file.

In a further aspect of an embodiment of the present invention, the computer program product may include computer readable program code for transmitting the cryptographically signed binary file to a secure element where it is housed.

In a further aspect of an embodiment of the present invention, the secured element of the computer program product may be a computer chip.

In a further aspect of an embodiment of the present invention, the secure element of the computer program product may be configured and enabled to be read via Near-field Communication (NFC) for verification purposes without a wireless network being present or being used.

A further aspect of an embodiment of the present invention contemplates a computer program product comprising a computer usable medium having computer executable instructions stored therein for causing a computer processor to implement operation of a retail cryptocurrency transaction financial network, the computer executable instructions comprising computer readable program code for: enabling purchase and installation of least one type of cryptocurrency as designated by the retail cryptocurrency transaction financial network, operation, by a retail location, of at least one point of sale terminal linked to the cryptocurrency transaction financial network, and operation of the retail cryptocurrency transaction financial network once the at least one API has been integrated with the retail location's payment platform.

A further aspect of an embodiment of the present invention contemplates a system configured towards implementation of a cryptocurrency transaction financial network/platform, comprising: at least one processor configured to perform a predefined set of basic operations in response to receiving a corresponding basic computer executable instruction selected from a predefined native instruction set of codes, at least one database, and at least one payment card, where said at least one payment card comprises of any one or more of: at least one Key Signature Pin, a biometric fingerprint sensor/sensor data, network/platform-related metadata.

In a further aspect of an embodiment of the present invention the system may further comprise of at least one point of sale (POS) device, where said POS device may verify a user's signature on said at least one payment card, where all components of said system are any one of: in communication with each other, in communication with at least one other element of said system.

In a further aspect of an embodiment of the present invention the system may further comprise of a module for capturing at least one user generated mnemonic phrase.

In a further aspect of an embodiment of the present invention said at least one user generated mnemonic phrase may comprise of a sequence of words.

In a further aspect of an embodiment of the present invention, any one or more of: at least one Key Signature Pin, a biometric fingerprint sensor data, network/platform-related metadata may be transferred wirelessly via NFC to a secure element inside of said at least one payment card.

In a further aspect of an embodiment of the present invention the system may further comprise of a module for encoding data related to transfer of funds from one account within the system to another account within the system, where said data is encoded as a QR Marker/QR code

In a further aspect of an embodiment of the present invention the system may further comprise of a module for enabling scanning of said QR Marker/QR code, where said scanning initiates exchange of currency.

In a further aspect of an embodiment of the present invention the system may further comprise of a module for validating at least one cryptographic signature belonging to a sending account, where said validation completes a transaction within said system.

A further aspect of an embodiment of the present invention contemplates a computer program product which may include a non-transitory computer readable medium having computer executable instructions stored therein for implementing operation of a retail cryptocurrency transaction financial network, comprising executing, on at least one processor configured to perform a predefined set of basic operations in response to receiving a corresponding basic computer executable instruction selected from a predefined native instruction set of codes, computer readable program code for: enabling purchase and installation of least one type of cryptocurrency as designated by the retail cryptocurrency transaction financial network, incorporation, by a retail location, of at least one application programming interface (API) linked or relevant to the at least one type of cryptocurrency into the retail location's payment platform, verification and authentication of a bioprint as received by at least one payment card, where the verification and authentication is undertaken by a verification and authentication module of the at least one payment card, and operation of the retail cryptocurrency transaction financial network once the at least one API has been integrated with the retail location's payment platform.

In a further aspect of an embodiment of the present invention the computer program product's computer readable code for operation of the verification and authentication module of the at least one payment card, may include computer readable program code for: receiving data on the at least one payment card, searching for data previously supplied by the user, where the data is stored on memory of the at least one payment card, comparing the received data with previously stored data located on the memory of the at least one payment card, and determining whether a match exists between the received data with previously supplied data already stored within the memory of the at least one payment card.

In a further aspect of an embodiment of the present invention the computer program product may additionally include computer readable code for transmitting confirmation of the match to a secure element where it is housed.

In a further aspect of an embodiment of the present invention, the secure element is configured and enabled to be read via Near-field Communication (NFC) for verification purposes without a wireless network being present or being used.

A yet further aspect of an embodiment of the present invention contemplates a computer-implemented method for implementing operation of a cryptocurrency transaction financial network/platform, comprising executing on at least one processor configured to perform a predefined set of basic operations in response to receiving a corresponding basic computer executable instruction selected from a predefined native instruction set of codes, the steps of: activating at least one account within said network, where said activation is done by a user's generation of a mnemonic phrase, where said mnemonic phrase comprises of at least one sequence of words, using said at least one sequence of words for account recovery purposes, wireless transfer of any one or more of: at least one Key Signature Pin, platform-related metadata, where said any one or more of at least one Key Signature Pin, platform-related metadata is transferred via NFC to a secure element inside of a payment card, utilization of at least one exchange to fund at least one account, where said at least one exchange supports said cryptocurrency transaction financial network.

In another yet further aspect of an embodiment of the present invention the computer-implemented method may further comprise the step of purchasing certain currency through an exchange with a fiat credit card.

In another yet further aspect of an embodiment of the present invention the computer-implemented method may further comprise the step of instant reflection of settled funds in a user's account.

In another yet further aspect of an embodiment of the present invention the computer-implemented method may further comprise the step of sending said settled funds directly to any other at least one account of said cryptocurrency transaction financial network.

In another yet further aspect of an embodiment of the present invention the computer-implemented method may further comprise the step of generating at least one transaction for specific amounts of cryptocurrency used within said cryptocurrency transaction financial network.

In another yet further aspect of an embodiment of the present invention the computer-implemented method may further comprise the step of encoding data related to the transfer of funds from at least one account to at least another account as a QR Marker/QR code.

In another yet further aspect of an embodiment of the present invention the computer-implemented method may further comprise the step of scanning QR Marker/QR code to initiate exchange of currency/cryptocurrency.

In another yet further aspect of an embodiment of the present invention the computer-implemented method may further comprise the step of validating the cryptographic signature belonging to at least one account.

A yet still further aspect of an embodiment of the present invention contemplates a computer program product comprising a computer usable medium having computer executable instructions stored therein for causing a computer processor to implement operation of a cryptocurrency transaction financial network/platform, said computer executable instructions comprising computer readable program code for: activating at least one account within said network, where said activation is done by a user's generation of a mnemonic phrase, where said mnemonic phrase comprises of at least one sequence of words, using said at least one sequence of words for account recovery purposes, wireless transfer of any one or more of: at least one Key Signature Pin, platform-related metadata, where said any one or more of at least one Key Signature Pin, platform-related metadata is transferred via NFC to a secure element inside of a payment card, utilization of at least one exchange to fund at least one account, where said at least one exchange supports said cryptocurrency transaction financial network.

In another yet still further aspect of an embodiment of the present invention, the computer program product may further comprise of computer readable program code for purchasing certain currency through an exchange with a fiat credit card.

In another yet still further aspect of an embodiment of the present invention, the computer program product may further comprise of computer readable program code for instant reflection of settled funds in a user's account.

In another yet still further aspect of an embodiment of the present invention, the computer program product may further comprise of computer readable program code for sending said settled funds directly to any other at least one account of said cryptocurrency transaction financial network.

In another yet still further aspect of an embodiment of the present invention, the computer program product may further comprise of computer readable program code for generating at least one transaction for specific amounts of cryptocurrency used within said cryptocurrency transaction financial network.

In another yet still further aspect of an embodiment of the present invention, the computer program product may further comprise of computer readable program code for encoding data related to the transfer of funds from at least one account to at least another account as a QR Marker/QR code.

In another yet still further aspect of an embodiment of the present invention, the computer program product may further comprise of computer readable program code for scanning QR Marker/QR code to initiate exchange of currency/cryptocurrency.

In another yet still further aspect of an embodiment of the present invention, the computer program product may further comprise of computer readable program code for validating the cryptographic signature belonging to at least one account.

### BRIEF DESCRIPTION OF THE DRAWINGS

Further objectives and advantages of the present invention may be derived by referring to the detailed description and claims when considered in connection with the Figures. The present invention is illustrated by way of example and not limitation in the accompanying figures, wherein like reference numbers refer to similar items throughout the Figures.

FIG. 1A illustrates a retail cryptocurrency transaction financial network/platform (or system) according to aspects of embodiments of the present invention.

FIGS. 1B-1C illustrates a point-of-sale device of a retail cryptocurrency transaction financial network/platform (or system) according to aspects of embodiments of the present invention.

FIGS. 1D & 1E illustrate a biometric fingerprint stored value card as a component of the contemplated system according to aspects of embodiments of the present invention.

FIG. 2 illustrates a retail cryptocurrency transaction financial network/platform (or system) according to another set of aspects of embodiments of the present invention.

FIG. 3 illustrates an operation of a retail cryptocurrency transaction financial network/platform (or system) according to aspects of embodiments of the present invention.

FIG. 4 illustrates an operation of a retail cryptocurrency transaction financial network/platform (or system) according to another set of aspects of embodiments of the present invention.

FIG. 5 illustrates a transaction flow between a payment card and a portable device and/or a point-of-sale device according to an aspect of an embodiment of the present invention.

FIGS. 6A-6D illustrate displays of a portable device of a cryptocurrency transaction financial network/platform showing display buttons according to an aspect of an embodiment of the present invention.

FIG. 7 illustrates a process of activating and account/transacting a transaction in conjunction with a retail cryptocurrency transaction financial network/platform (or system) according to aspects of embodiments of the present invention.

### DETAILED DESCRIPTION OF THE INVENTION

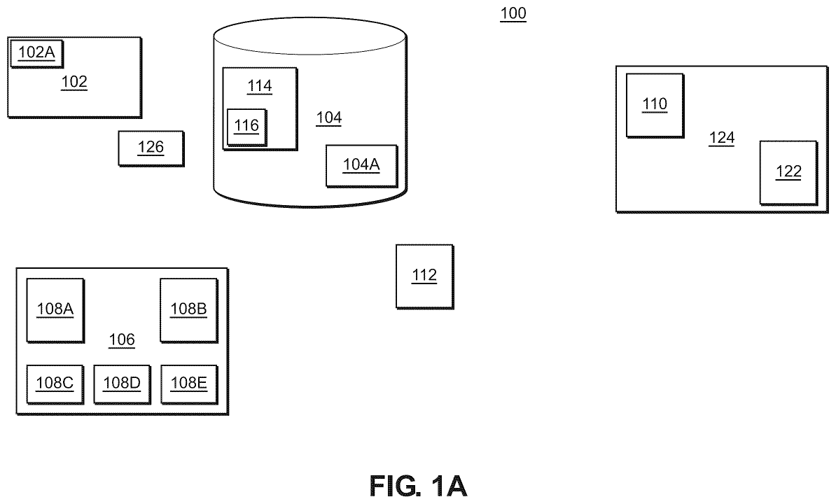

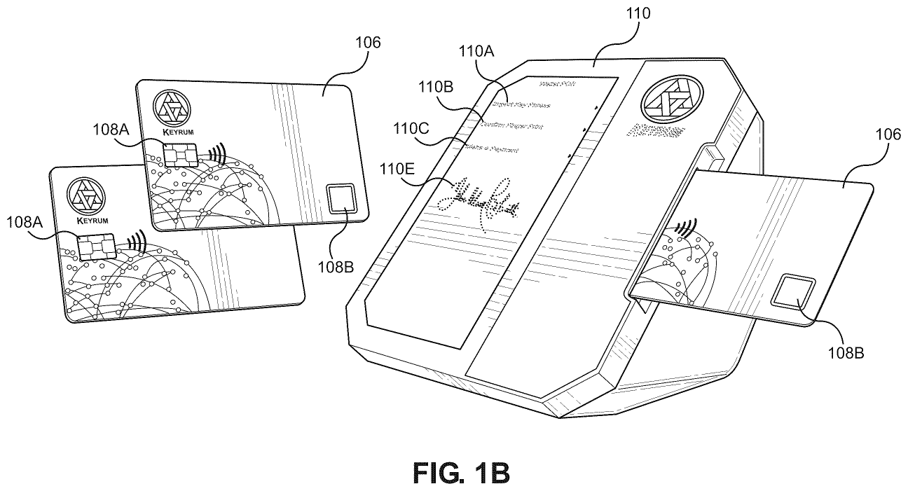

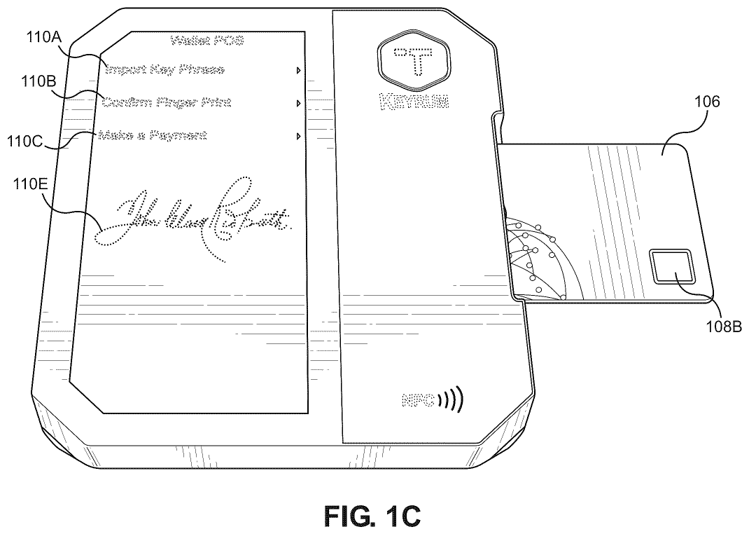

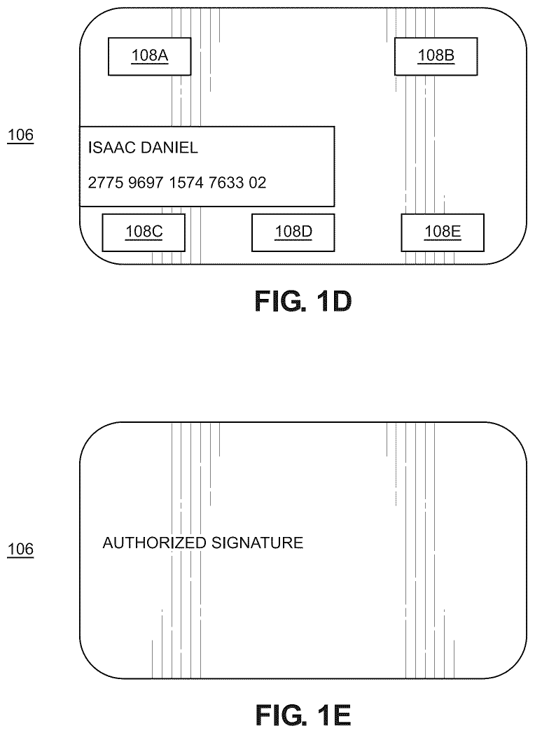

Referring now to FIGS. 1A-1C, a retail cryptocurrency transaction financial network/platform 100 along with certain components of same are shown according to aspects of embodiments of the present invention. Network/platform 100 may include: at least one processor 102, where processor(s) 102 may be configured to perform a predefined set of basic operations in response to receiving a corresponding basic computer executable instruction selected from a predefined native instruction set of codes. Network/platform 100 may also include at least one database or memory 104, at least one payment card 106, where at least one payment card 106 may include any one or more of: a Key Signature pin 108A, a biometric fingerprint sensor 108B. Key signature pin 108A may, in an aspect of an embodiment of the present invention, be a pair of RSA (i.e., Rivest-Shamir-Adleman) keys where the private key from the pair may be used to sign certificate requests and transactions. Network/platform 100 may also include at least one point of sale (POS) device, where POS device 110 verifies a user's signature on at least one payment card 106. In an aspect of an embodiment of the present invention, all components of network/platform 100 may be any one of: in communication with each other, in communication with at least one other element of network/platform 100.

In an aspect of an embodiment of the present invention, the at least one payment card 106 may include a verification and authentication module 108C which may be configured to integrate the functionality of a combined or separate fingerprint sensor and chip, thereby ensuring the card's robust biometric security. In an aspect of an embodiment of the present invention, the verification and authentication module 108C may operate to verify and authenticate a user's bioprint as captured by biometric fingerprint sensor 108B. Verification and authentication may be made possible by matching the received bioprint with bioprint data stored on at least one payment card 106 in storage 108D.

In another aspect of an embodiment of the present invention, at least one payment card 106 may include transceiver 108E which may enable verification and authentication module 108C to compare and/or match the received bioprint with bioprint data stored beyond at least one payment card 106, such as at least one database or memory 104 of network/platform 100. In such an aspect, upon receipt of the bioprint, verification and authentication module 108C would send the received bioprint via transceiver 108E to network/platform 100, which may in one aspect of an embodiment of the present invention, may include, but not be limited to, at least one database or memory 104 of network/platform 100, which may have its own verification and authentication module, 102A. In an aspect of an embodiment of the present invention, verification and authentication module, 102A may be a component/function of processor(s) 102 or, in another aspect of an embodiment of the present invention, a separate component of network/platform 100. In an aspect of an embodiment of the present invention, the verification and authentication processing may be done by processor(s) 102, which would then match the bioprint data received from at least one payment card 106 with bioprint data 104A stored on database or memory 104. Upon matching the bioprint data, processor(s) 102 would then send, via transceiver 126 of network/platform 100 (which may also function to receive information from at least one payment card 106), the verified/authenticated status of the bioprint back to at least one payment card 106, which would receive the confirmation via transceiver 108E, thereby providing the user access to at least one payment card 106.

If there is no match, processor(s) 102 would then send the no match message to at least one payment card 106, which upon receipt, would deny at least one payment card 106 access to the user providing the unmatched, unverified bioprint.

In an aspect of an embodiment of the present invention, network/platform 100 may further include at least one portable device 112, in communication with any one or more of: at least one processor 102, at least one database 104, at least one POS, at least one payment card 106, where at least one portable device 112 may include any one or a combination of: a biometric module 112A, biometric information 112B, a transceiver module 112C, a computer processor unit 112D, coded information 112E, data 112F, memory 112G.

In an aspect of an embodiment of the present invention, network/platform 100 may further include text data 114 stored on at least one database 104. In an aspect of an embodiment of the present invention, text data 114 may include at least one captured signature image 116. In an aspect of an embodiment of the present invention, text data 114 may be encoded into a cryptographically signed binary file 118.

In an aspect of an embodiment of the present invention, network/platform 100 may further include at least one stored element 120, where cryptographically signed binary file 118 may be transmitted to at least one stored element 120 and where at least one stored element 120 may be read via Near-Field Communication (NFC). Stored element 120 may be located in any one or more of: database 104, POS 110, payment card 106, portable device 112.

In an aspect of an embodiment of the present invention, network/platform 100 may include at least one application programming interface (API) 122 which may be installed onto POS device 110 or may be resident on at least one database 104.

In an aspect of an embodiment of the present invention, network/platform 100 may include retail location 124 where POS device 110 may be located.

In an aspect of an embodiment of the present invention, network/platform 100 may also include secure element 126 which may be located on at least one database 104.

Referring now to FIGS. 1D and 1E, front and rear views of a biometric fingerprint stored value card 106 of system 100 are shown according to aspects of embodiments of the present invention. In an aspect of an embodiment of the present invention, the at least one payment card 106 may include Key Signature pin 108A, biometric fingerprint sensor 108B, for capturing a user's bioprint, verification and authentication module 108C, memory or storage 108D, and transceiver 108E.

In an aspect of an embodiment of the present invention, verification and authentication module 108C may be configured to integrate the functionality of a combined or separate fingerprint sensor and chip, thereby ensuring the card's robust biometric security. In an aspect of an embodiment of the present invention, verification and authentication module 108C may operate to verify and authenticate a user's bioprint as captured by biometric fingerprint sensor 108B. Verification and authentication may be made possible by matching the received bioprint with bioprint data stored on at least one payment card 106 in storage 108D.

In another aspect of an embodiment of the present invention, at least one payment card 106 may include transceiver 108E, which may enable verification and authentication module 108C to compare and/or match the received bioprint with bioprint data stored beyond at least one payment card 106, such as at least one database or memory 104 of network/platform 100. In such an aspect, upon receipt of the bioprint, verification and authentication module 108C would send the received bioprint via transceiver 108E to network/platform 100, which may in one aspect of an embodiment of the present invention, may include, but not be limited to, at least one database or memory 104 of network/platform 100, which may have its own verification and authentication module, 102A.

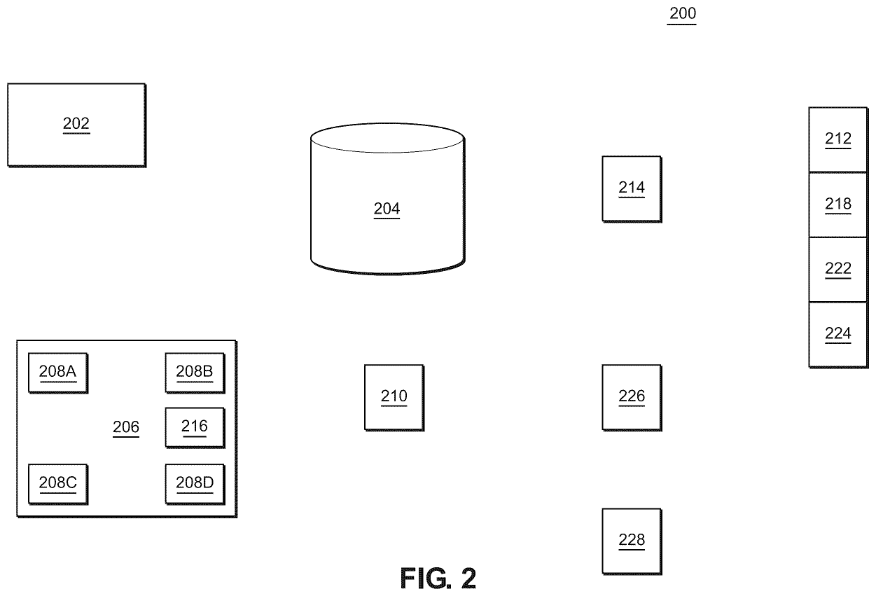

Referring now to FIG. 2, a retail cryptocurrency transaction financial network/platform 200 is shown according to another set of aspects of embodiments of the present invention. Network/platform 200 may include at least one processor 202 which may be configured towards implementation of a cryptocurrency transaction financial network/platform, where at least one processor 202 may be configured to perform a predefined set of basic operations in response to receiving a corresponding basic computer executable instruction selected from a predefined native instruction set of codes, all for the operation of network/platform 200.

In an aspect of an embodiment of the present invention, network/platform 200 may include at least one database or memory 204, and at least one payment card 206, where at least one payment card 206 comprises of any one or more of: at least one Key Signature Pin 208A, a biometric fingerprint sensor 208B, sensor data 208C, network/platform-related metadata 208D. Key signature pin 208A may, in an aspect of an embodiment of the present invention, be a pair of RSA keys where the private key from the pai may be used to sign certificate requests and transactions.

In a further aspect of an embodiment of the present invention, network/platform 100 may further comprise of at least one point of sale (POS) device 210, where POS device 210 may be used to verify a user's signature 226 on at least one payment card 206. In an aspect of an embodiment of the present invention, all components of network/platform 200 are any one of: in communication with each other, in communication with at least one other element of said network/platform 200.

In a further aspect of an embodiment of the present invention network/platform 200 may further comprise of a module 212 for capturing at least one user generated mnemonic phrase 214. In a further aspect of an embodiment of the present invention at least one user generated mnemonic phrase 214 may comprise of a sequence of words.

In an aspect of an embodiment of the present invention, network 200 may manage access and identities with a cold storage solution, whereby private keys may be generated and/or stored offline. In one aspect of an embodiment of the present invention, to activate an account on network 200, a user may, in addition to other generate mnemonic phrase 214 and the sequence of words can be used for a variety of purposes, including account sign in, account recovery etc. Newly created keys and platform related metadata may be transferred wirelessly via NFC to payment card 206 which may have a secure element 216 or equivalent for storage of the keys/metadata.

In a further aspect of an embodiment of the present invention, any one or more of: at least one Key Signature 226 Pin 208A, a biometric fingerprint sensor 208B data, network/platform-related metadata 208D may be transferred wirelessly via NFC to a secure element 216 inside of said at least one payment card 206.

In a further aspect of an embodiment of the present invention network/platform 200 may further comprise of a module 218 for encoding data related to transfer of funds from one account within network/platform 200 to another account within network/platform 100, where said data may be encoded as a QR Marker/QR code 220

In a further aspect of an embodiment of the present invention network/platform 100 may further comprise of a module 222 for enabling scanning of said QR Marker/QR code 220, where said scanning initiates exchange of currency.

In a further aspect of an embodiment of the present invention network/platform 200 may further comprise of a module 224 for validating at least one cryptographic signature 226 belonging to a sending account, where said validation completes a transaction within said network/platform 200.

In an aspect of an embodiment of the present invention, a merchant may generate a transaction requiring specific amounts of cryptocurrency. In one aspect, the merchant, using POS 210 may encode (using module 218) the transaction (e.g. information related to a purchase such as cost, type of goods/service etc.) as QR Marker/QR code 220. A user may then scan the QR Marker/QR code 220 using a portable device 228 using the application (“app”) associated with network 200. The transaction may then be completed when network 200 validates the cryptographic signature 226.

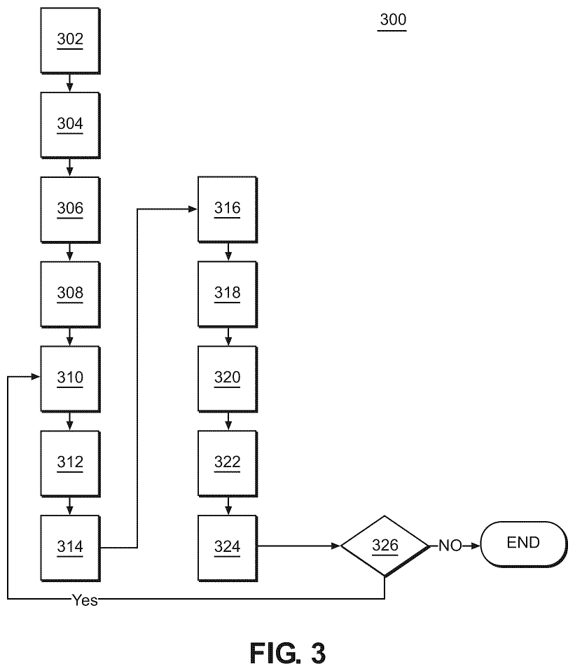

Referring now to FIG. 3, a process 300 illustrating operation of a retail cryptocurrency transaction financial network/platform 100 is shown according to aspects of embodiments of the present invention. Such operation may be made possible by operation of at least one processor 102, which, in an aspect of an embodiment of the present invention, may be configured to perform a predefined set of basic operations in response to receiving a corresponding basic computer executable instruction selected from a predefined native instruction set of codes in the implementation of process 300's steps. Process 300 starts at step 302 with the enabling of the purchase and installation of least one type of cryptocurrency as designated by retail cryptocurrency transaction financial network 100. Next at step 304, at least one application programming interface (API) 122, linked or relevant to at least one type of cryptocurrency, may be incorporated by retail location 124 into the retail location 124's payment platform. Next, in step 306, operation of the retail cryptocurrency transaction financial network 100 is undertaken once at least one API 122 has been integrated into retail location 124's payment platform. Next in step 308 is the operation, by retail location 124, of at least one point of sale terminal 110 linked to the cryptocurrency transaction financial network 100.

Once steps 302-308 have been undertaken, network/platform 100 then proceeds with the steps of verifying a user's signature on a payment card instantly. These verification steps start with step 310, i.e., receiving data (e.g., any one or a combination of: biometric information 112B, coded information 112E, and/or data 112F) from at least one payment card 106, searching for data (e.g., text data 114) previously supplied by the user (step 312), where the data may have been obtained by an Optical Character Recognition (OCR) process during the user's application for at least any one or more of: a credit card, debit card, cryptocurrency payment card or digital wallet, and where the data may be sent from at least one device 112, submitting (step 314) the received data to a centralized database, such as, in one aspect of an embodiment of the present invention, database 104, comparing the received data with data located within the centralized database (e.g., text data 114) (step 316), matching the received data with previously supplied data already within the centralized database (e.g., text data 114) (step 318), extracting text data 114 from the previously supplied data already within the centralized database 104 (step 320), and encoding text data 114 from the previously supplied data already within the centralized database (step 322).

In another aspect of an embodiment of the present invention, the received data in step 312 may include any one of: an entire captured signature image, a portion of a captured signature image.

In another aspect of an embodiment of the present invention, the encoded text data 114 in step 322 may be encoded into a cryptographically signed binary file 118.

In another aspect of an embodiment of the present invention, the validity of the cryptographically signed binary file 118 may be confirmed by comparing its signature to an expected signature based on supplied parameters.

In another aspect of an embodiment of the present invention, process 300 may next comprise the step of transmitting signed binary file 118 to a secure element 124 where it may be housed (step 324). In another aspect of an embodiment of the present invention, secure element 124 may be a computer chip. In another aspect of an embodiment of the present invention, secure element 124 may be configured and enabled to be read via Near-field Communication (NFC) for verification purposes without a wireless network being present or being used.

Following step 324, processor 100 then determines whether a new transaction is to be undertaken in step 326. If so, process 300 proceeds to step 310. If not, the process ends.

A further aspect of an embodiment of the present invention contemplates use of a computer program product comprising a computer usable medium having computer executable instructions stored therein for operation of at least one processor 102, which, in an aspect of an embodiment of the present invention, may be configured to perform a predefined set of basic operations in response to receiving a corresponding basic computer executable instruction selected from a predefined native instruction set of codes in the implementation of process 300's steps outlined above.

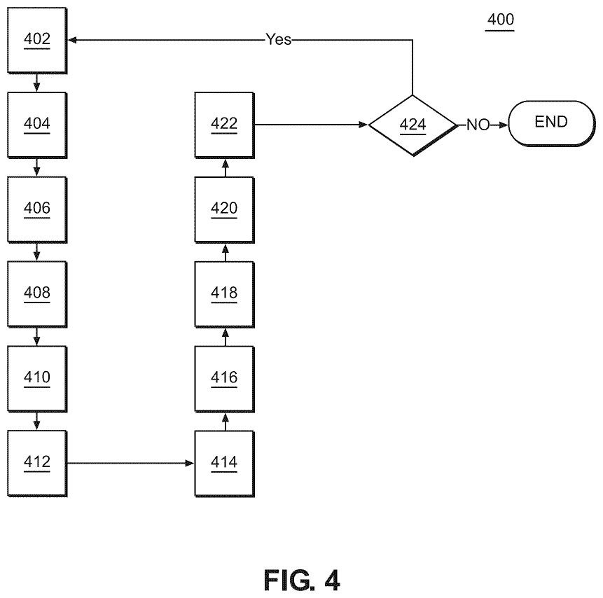

Referring now to FIG. 4, a process 400 outlining a computer-implemented method for implementing operation of a cryptocurrency transaction financial network/platform 200 is shown according to another set of aspects of embodiments of the present invention. In an aspect of an embodiment of the present invention process 400 contemplates use of at least one processor 202 for this implementation which may involve executing on at least one processor 202 configured to perform a predefined set of basic operations in response to receiving a corresponding basic computer executable instruction selected from a predefined native instruction set of codes, the steps of: activating at least one account within said network (step 402), where the activation may be done by a user's generation of a mnemonic phrase 214, where mnemonic phrase 214 may include at least one sequence of words. Process 400 may then proceed to step 404, i.e., using the at least one sequence of words for account recovery purposes, which then proceeds to step 406 which would involve the wireless transfer of any one or more of: at least one Key Signature pin 208A, platform-related metadata 208D, where said any one or more of at least one Key Signature pin 208A, platform-related metadata 208D may be transferred via NFC to a secure element 216 inside of a payment card 206. After this, process 400 proceeds to step 408 which is the utilization of at least one exchange to fund at least one account, where said at least one exchange supports said cryptocurrency transaction financial network.

Process 400 then proceeds to the step of purchasing certain currency through an exchange with a fiat credit card (step 410), followed by step 412 which involves the instant reflection of settled funds in a user's account. After this, process 400 proceeds to step 414 which involves sending the settled funds directly to at least one account of the cryptocurrency transaction financial network 200.

Next, process 400 proceeds to the step of generating at least one transaction for specific amounts of cryptocurrency used within said cryptocurrency transaction financial network (step 416), after which data related to the transfer of funds from at least one account to at least another account is encoded as a QR Marker/QR code (step 418). The QR Marker/QR code may then be scanned to initiate exchange of currency/cryptocurrency (step 420) and the cryptographic signature 226 belonging to at least one account may then be validated (step 422). After step 422, processor 202 determines whether, in step 424 another account is to be activated. If so, process 400 proceeds to step 402. If not, process 400 ends.

A further aspect of an embodiment of the present invention contemplates use of a computer program product comprising a computer usable medium having computer executable instructions stored therein for operation of at least one processor 202, which, in an aspect of an embodiment of the present invention, may be configured to perform a predefined set of basic operations in response to receiving a corresponding basic computer executable instruction selected from a predefined native instruction set of codes in the implementation of process 400's steps outlined above.

Additional aspects of embodiments of the present invention contemplate a computer program product comprising a computer usable medium having computer executable instructions stored therein for causing a computer processor 202 to implement operation of a cryptocurrency transaction financial network/platform, where the computer executable instructions may include computer readable program code for undertaking or implementing the steps of process 400 outlined above.

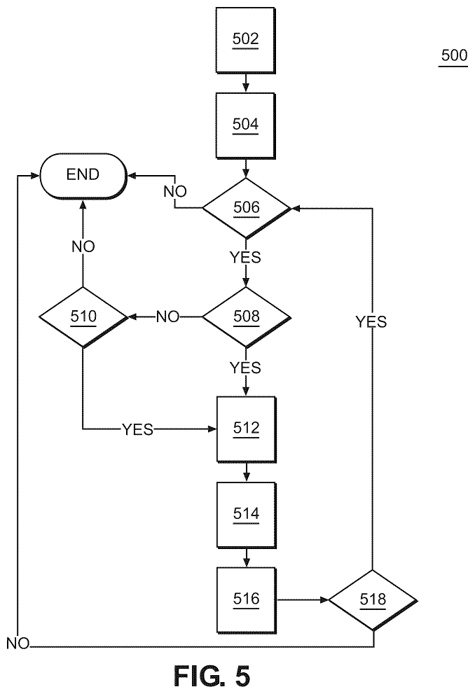

Referring now to FIG. 5, a transaction flow 500 between a payment card 106 and a portable device 112 and/or a point-of-sale device 110 is shown according to an aspect of an embodiment of the present invention.

Process 500 begins at the point at which a user is ready to pay for certain goods or services in a desired transaction on a merchant device such as portable device 112 (such as the user's mobile device e.g., phone, laptop, tablet, or the like) or at a retail merchant location 122's POS device 110. In step 502, the user then brings payment card 106 close enough to the merchant device to enable electronic communication between payment card 106 and merchant device via NFC communication. Once contact has been made, the merchant device receives the amount on payment card 106 (step 504) and the merchant device determines, in step 506 as to whether there are sufficient funds on payment card 106 for the desired transaction. If there are sufficient funds, the process goes either to step 508 or step 512 (see below). If there are insufficient funds, the process ends. In an aspect of an embodiment of the present invention, process 500 may include step 508 where the user may be prompted to provide a signature on the merchant device to validate their ability to use payment card 106. The merchant device may then communicate with network 100 or 200 to determine whether there is a match with signature image 116. If so, then process 500 proceeds to step 512 where the cryptocurrency on payment card 106 is converted to the fiat currency amount needed for the desired transaction. If there is not a match, the user may be prompted again to re-enter the user's signature in step 510. If there is a match, then the process goes to step 512. If there is no match, then the process ends in a number of ways, including providing the user with an error message, a message that the transaction is not authorized, or a message that the signature did not match.

Following step 512, process 500 then proceeds to step 514 where the converted amount is transmitted to the merchant device. The user, in step 516, is then presented with a balance of the remaining cryptocurrency funds on payment card 106 on portable device 112. The merchant device then, in step 518 inquires as to whether the user wants to conduct another transaction. If so, process 500 proceeds to step 506, if not, the process ends.

Additional aspects of embodiments of the present invention contemplate a computer program product comprising a computer usable medium having computer executable instructions stored therein for causing a computer processor resident on the merchant device to implement operation of a cryptocurrency transaction financial network/platform, where the computer executable instructions may include computer readable program code for undertaking or implementing the steps of process 500 outlined above.

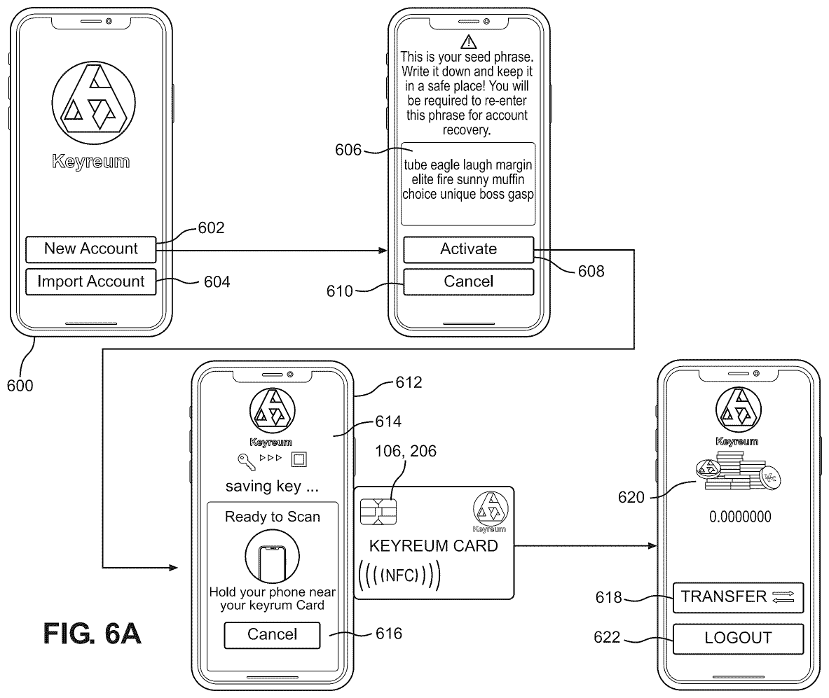

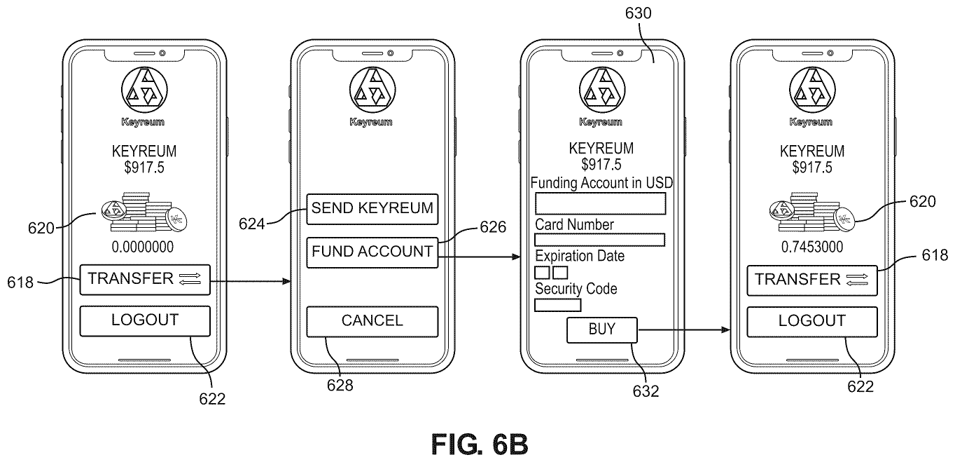

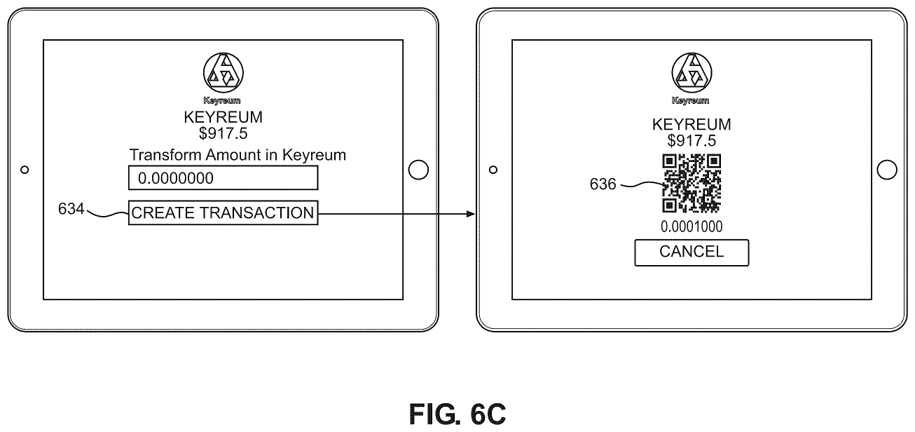

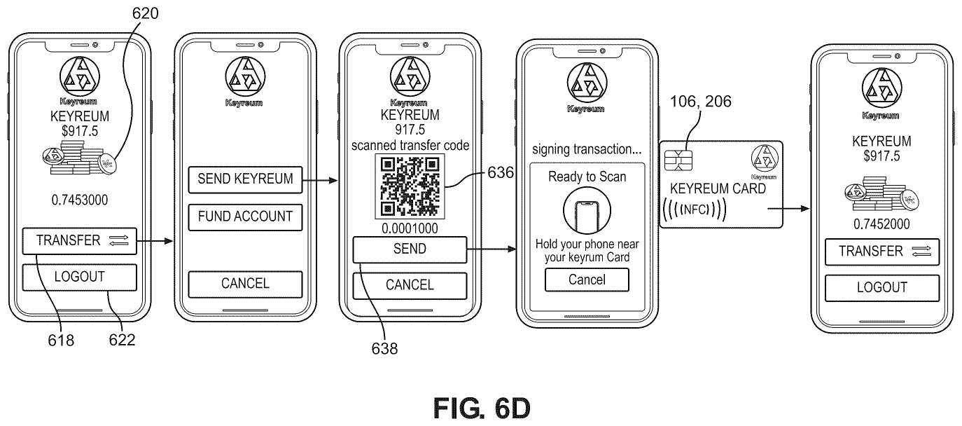

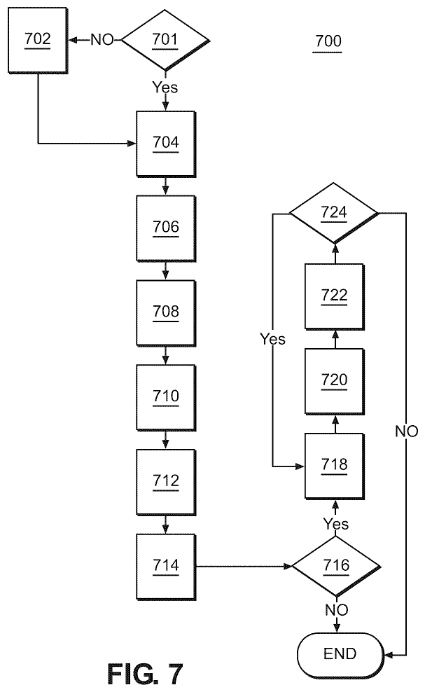

Referring now to FIGS. 6A-6D, and 7, displays of a portable device 600 of a cryptocurrency transaction financial network/platform (such as 100 or 200) showing display buttons and the process 700 of activating and account/transacting a transaction are all shown according to aspects of embodiments of the present invention.

Process 700 begins following download of the application (“app”) associated with network 100 or 200 onto portable device 600 (which may be the same or similar to portable device 106, 206). At step 702 a user is asked whether this is a new account. The user may then select display button 602 for a new account. If the user intends to import an existing account, then button 604 is selected. Next, the user is prompted in step 704 to enter a mnemonic phrase such as mnemonic phrase 214 into display box 606. The user may also be required to provide additional information or data. Process 700 then proceeds to activation step 706 with the user's selection of button 608. The user could also stop the process by selecting button 610. Device 600 may then in step 708 generate an RSA key 612 (such as key 108A or 208A) or a QR code 614 (such as QR Marker/QR code 220).

Payment card 106 or 206 in step 710 is then scanned for the generated keys/QR code to be transmitted (step 712) to payment card 106 or 206 via NFC connection and stored therein. Once done, the data is all transmitted to the cryptocurrency transaction financial network/platform (such as 100 or 200) in step 714 with the account information displayed 620.

The cryptocurrency's value is based on market price. The currency can be purchased through an exchange with a fiat credit card. Settled funds are instantly reflected in a user's account and can be sent directly to any other cryptocurrency account.

The user may then in step 716 be presented via button 618 with the option of funding the new account by way of cryptocurrency transfer or fiat bank funding. If the user opts to fund the account, process 700 proceeds to step 718. If not, the process ends.

At step 718 may fund the account using cryptocurrency (button 624) or use a fiat bank account (button 626). Next, at funding step 720, the different displays for funding, 630 for fiat funding; 632 for cryptocurrency transfer/purchase, are displayed for the user to select and input requisite information. Funding using fiat accounts would engage transfer of same and conversion into the cryptocurrency equivalent. Thus, in an aspect of an embodiment of the present invention, payment card is funded. Once the funding is done (step 722), the amount funded is displayed (620), and the user is presented with the option (step 724) as to whether to transfer additional funds. If so, process 700 proceeds to step 726, if not, the process ends.

At step 726, the user is asked whether the transfer is for a transaction (e.g., purchase). If it is a purchase, then process 700 proceeds to step 728 where a merchant creates a transaction (e.g., by scanning an article and finalizing the purchase) and a QR code is generated reflecting the transaction. User may then scan the merchant-generated QR code 636 (step 730) onto portable device or may then begin the process of payment by selecting the send or scan button 638 to, in step 732, to scan payment card (e.g. payment card 106 or 206). In an aspect of an embodiment of the present invention, portable device, via NFC communication, may read the amount on payment card to determine whether enough funds are present to pay for the transaction (step 734). In another alternative aspect, the payment card's information may be sent to the cryptocurrency transaction financial network/platform (such as 100 or 200) to approve the transaction (step 734). If approved/enough funds exist, the transaction is completed (step 736). If there are insufficient funds, then the process may stop, error messages may be sent or insufficient funds messages may be displayed.

Additional aspects of embodiments of the present invention contemplate a computer program product comprising a computer usable medium having computer executable instructions stored therein for causing a computer processor resident on the merchant device or a portable device to implement operation of a cryptocurrency transaction financial network/platform, where the computer executable instructions may include computer readable program code for undertaking or implementing the steps of process 700 outlined above.

Aspects of embodiments of the present invention contemplate computer implemented methods, processes, systems, computer program product (comprising a computer usable medium having computer executable instructions stored therein for causing a computer processor to perform certain operations), and devices directed to the full operation and functionality of a system configured towards implementation and operation of a retail cryptocurrency transaction financial network and/or devices as disclosed above.

In an aspect of an embodiment of the present invention, the term “module” may represent self-contained computer hardware. In another aspect of an embodiment of the present invention, the term “module” may represent computer hardware on a designated computer chip or separate computer chips. In yet another aspect of an embodiment of the present invention, the processor may be configured to perform tasks not undertaken by the module(s) disclosed herein. In a further aspect of an embodiment of the present invention, the modules may be hardware resident on one chip, component, separate components, a remote server, database, some or each of which (or all of which, in one aspect of an embodiment of the present invention) may be separate and distinct from the device, or any combination thereof. In one aspect of an embodiment of the present invention, the processor may be configured to coordinate, implement and/or assign tasks to, from and/or among the module(s). In a further aspect of an embodiment of the present invention, module components may also, in an operational context, be components of other modules.

In a further aspect of an embodiment of the present invention, steps, processes, operations or methods undertaken by the systems and/or system components, as discussed above, may be implemented by execution, on one or more servers or processors configured to perform a predefined set of basic operations in response to receiving a corresponding basic instruction selected from a predefined native instruction set of codes. This native instruction set of codes or machine language instruction codes may be built into servers/processors of system components. As such, different operations contemplated by the disclosure above, may be made possible by the selection of machine codes from specific machine language instruction codes. Additional complex operations may be made possible by the combination of different sets of machine language instruction codes.

Further aspects of embodiments of the present invention contemplate the use of non-transitory computer programmable product and computer-implemented methods for the implementation of the different processes outlined above. The same may be found installed on any or all of the components discussed in this application including, without limitation, the mobile device(s), registries, etc.

Yet further aspects of embodiments of the present invention contemplate execution of computer code resident on devices, system of devices, and communication media such as wide area networks, the internet etc. enabling the contemplated transactions.

Although this present invention has been disclosed with reference to specific forms and embodiments, it will be evident that a considerable number of variations may be made without departing from the spirit and scope of the present invention. For example, steps may be reversed, equivalent elements may be substituted for those specifically disclosed, certain features of the present invention may be used independently of other features, different aspects of embodiments of the invention may be used across other aspects and/or embodiments-all without departing from the present invention as outlined above, in the appended figures and the claims presented below.

What is claimed is:

1. A system configured towards implementation of a retail cryptocurrency transaction financial network, comprising:
at least one processor configured to perform a predefined set of basic operations in response to receiving a corresponding basic computer executable instruction selected from a predefined native instruction set of codes;
at least one database;
at least one payment card, wherein said at least one payment card comprises of any one or more of: a Key Signature Pin, a biometric fingerprint sensor, a verification and authentication module, a transceiver, memory;
a transceiver; and
at least one point of sale (POS) device, wherein said POS device verifies a user's signature on said at least one payment card, wherein all components of said system are any one of: in communication with each other, in communication with at least one other element of said system.

2. The system of claim 1, further comprising of at least one portable device, in communication with any one or more of: said at least one processor, at least one database, at least one POS, at least one payment card, wherein said at least one portable device comprises of any one or a combination of: a biometric module, biometric information, a transceiver module, a computer processor unit, coded information, memory.

3. The system of claim 1, further comprising of bioprint data stored on said memory of said at least one payment card.

4. The system of claim 3, wherein said bioprint data is encoded into a cryptographically signed binary file.

5. The system of claim 4, further comprising at least one stored element, wherein said cryptographically signed binary file is transmitted to said at least one stored element and wherein said at least one stored element may be read via Near-Field Communication (NFC).

6. A computer-implemented method for implementing operation of a retail cryptocurrency transaction financial network, comprising executing, on at least one processor configured to perform a predefined set of basic operations in response to receiving a corresponding basic computer executable instruction selected from a predefined native instruction set of codes, steps of:
enabling purchase and installation of least one type of cryptocurrency as designated by the retail cryptocurrency transaction financial network;
incorporation, by a retail location, of at least one application programming interface (API) linked or relevant to the at least one type of cryptocurrency into the retail location's payment platform;
verification and authentication of a bioprint as received by at least one payment card, wherein said verification and authentication is undertaken by a verification and authentication module of said at least one payment card; and
operation of the retail cryptocurrency transaction financial network once the at least one API has been integrated with said retail location's payment platform.

7. The computer-implemented method of claim 6 undertaken by said verification and authentication module of said at least one payment card, comprising steps of:
receiving data on said at least one payment card;
searching for data previously supplied by said user, wherein said data is stored on memory of said at least one payment card;
comparing said received data with previously stored data located on said memory of said at least one payment card; and
determining whether a match exists between said received data with previously supplied data already stored within said memory of said at least one payment card.

8. The computer-implemented method of claim 7, further comprising the step of transmitting confirmation of said match to a secure element where it is housed.

9. The computer-implemented method of claim 8, wherein said secure element is configured and enabled to be read via Near-field Communication (NFC) for verification purposes without a wireless network being present or being used.

10. A computer program product comprising a non-transitory computer readable medium having computer executable instructions stored therein for implementing operation of a retail cryptocurrency transaction financial network, comprising executing, on at least one processor configured to perform a predefined set of basic operations in response to receiving a corresponding basic computer executable instruction selected from a predefined native instruction set of codes, computer readable program code for:
enabling purchase and installation of least one type of cryptocurrency as designated by the retail cryptocurrency transaction financial network;
incorporation, by a retail location, of at least one application programming interface (API) linked or relevant to the at least one type of cryptocurrency into the retail location's payment platform;
verification and authentication of a bioprint as received by at least one payment card, wherein said verification and authentication is undertaken by a verification and authentication module of said at least one payment card; and
operation of the retail cryptocurrency transaction financial network once the at least one API has been integrated with said retail location's payment platform.

11. The computer program product of claim 10, wherein said computer readable code for operation of said verification and authentication module of said at least one payment card, comprising computer readable program code for:
receiving data on said at least one payment card;
searching for data previously supplied by said user, wherein said data is stored on memory of said at least one payment card;
comparing said received data with previously stored data located on said memory of said at least one payment card; and
determining whether a match exists between said received data with previously supplied data already stored within said memory of said at least one payment card.

12. The computer program product of claim 11, further computer readable code for transmitting confirmation of said match to a secure element where it is housed.

13. The computer program product of claim 12, wherein said secure element is configured and enabled to be read via Near-field Communication (NFC) for verification purposes without a wireless network being present or being used.
